(19) United States
(12) Patent Application Publication
(10) Pub. No.: US 2010/0053262 A1
(43) Pub. Date: Mar. 4, 2010

(54) INK-DISCHARGING APPARATUS

(75) Inventors: Chiyoshi Yoshioka, Osaka (JP); Toshihiro Tamura, Osaka-shi (JP)

Correspondence Address: EDWARDS ANGELL PALMER & DODGE LLP, P.O. BOX 55874, BOSTON, MA, 02205, US

(73) Assignee: SHARP KABUSHIKI KAISHA, OSAKA (JP)

(21) Appl. No.: 12/448,617

(22) PCT Filed: Dec. 25, 2007
(86) PCT No.: PCT/JP2007/074865

§ 371 Date: Jun. 25, 2009

(30) Foreign Application Priority Data
Dec. 26, 2006 (JP) 2006-350637

(51) Int. Cl. B41J 23/00

(52) U.S. Cl. 347/37

(57) ABSTRACT

A discharging head turns from a main scanning direction into the opposite main scanning direction in a short period of time in moving from one target of ink discharge to another. An ink-discharging apparatus of the present invention is arranged such that: ink-discharging means takes longer to move from one target of positive-direction discharge (2a) to another (2c) along main-scanning directions than along sub-scanning directions and takes longer to move from one of the targets of negative-direction discharge (2b) to another (2b) along the main-scanning directions than along the sub-scanning directions; the ink-discharging means takes longer to move from the last one of the targets of positive-direction discharge (2a) to the first one of the targets of negative-direction discharge along the sub-scanning directions than along the main scanning directions, the last target of positive-direction discharge being a target of positive-direction discharge that the ink-discharging means scans last among the targets of positive-direction discharge, the first target of negative-direction discharge being a target of negative-direction discharge that the ink-discharging means scans first among the targets of negative-direction discharge; and the ink-discharging means starts to move along the sub-scanning directions toward the first target of second-direction discharge in starting to move from the last target of positive-direction discharge to the first target of negative-direction discharge.

### TECHNICAL FIELD

The present invention relates to ink-discharging apparatuses and, in particular, to an ink-discharging apparatus whose ink-discharging means turns from a main scanning direction into the opposite main scanning direction.

### BACKGROUND ART

In recent years, techniques for discharging ink, which have been originally used for consumer printers, have been widely diverted to liquid-crystal CFs (color filters) panel production apparatuses and other production apparatuses, and as such, have diversified their uses.

An example of the uses is an ink-jet patterning technique for forming a pattern on a substrate with use of a technique for discharging ink. The ink-jet patterning technique is a technique of printing a micropattern directly on a substrate by discharging minute amounts of liquid such as ink from an ink-discharging apparatus. The ink-jet patterning technique, which replaces a conventional photolithographic method for generating a pattern with use of a vacuum process, has drawn attention as a technique that can be used in a vacuum-free process.

In recent years, the development of an apparatus for forming a CF panel with use of the ink-jet patterning technique has been advanced. The apparatus forms a CF panel by causing red (R) ink, green (G) ink, and blue (B) ink to land into RGB pixels formed on a glass substrate and thereby filling in the pixels. The apparatus is used, in particular, for manufacturing liquid-crystal CF panels whose areas have been made increasingly larger in recent years. Moreover, the processing time of the apparatus is controlled so tightly that the apparatus is required to complete a process surely within a short period of time.

As shown in FIG. 9, a conventional CF panel has pixels 101, i.e., objects of printing arranged along main scanning directions Y and sub-scanning directions X in such a way as to form a reticular pattern. Therefore, according to a method for printing pixels on an entire surface of the conventional CF panel, it is usual for a discharging head to move alternately in directions, orthogonal to the main scanning directions Y and the sub-scanning directions X, which correspond to rows and columns of pixels, and to discharge ink after arriving at a destination (e.g., see Patent Literature 1). It should be noted that the arrows of FIG. 9 indicate a migration pathway of the discharging head.

Further, the ink-jet patterning technique has been widely used as a technique for repairing defective pixels such as those seen in cases of color mixtures, commingling of foreign substances, and adhesion of foreign substances (e.g., see Patent Literature 2), as well as a technique for printing pixels on the entire surface. As a method for repairing defective pixels, such a method for repairing an ink layer of a defective pixel whose color of ink has been mixed with the color of ink of an adjacent pixel due to ink leakage is used that repairs the ink layer by removing the ink layer with use of a laser apparatus or the like and by using the ink-jet patterning technique to again discharge, into a portion from which the ink layer has been removed, ink of a color designated from among RGB.

As a method for moving a discharging head of an ink-discharging apparatus to a defective pixel in carrying out such repairs as described above, such a method is used that moves the discharging head in a two-dimensional direction in accordance with the X-Y coordinates of the repairing position and, when the discharging head arrives at the destination, fills in the defective pixel by discharging a predetermined number of droplets of ink. As the method for moving the discharging head in a two-dimensional direction, an X-Y plotter method and a method for repeating movements alternately in main scanning and sub-scanning directions are widely used.

The X-Y plotter method is a method by which, on the assumption that the main scanning directions are directions of a Y-coordinate axis and the sub-scanning directions are directions of an X-coordinate axis, defective parts are reordered simply in accordance with their Y-coordinate values and the defective parts thus reordered are repaired in ascending or descending order. For example, assume, as shown in FIG. 10, that there are a plurality of pixel printing object portions 202 scattered about on a substrate 204. In this case, according to the X-Y plotter method, the discharging head repairs the pixel printing object portions 202 while moving over the pixel printing object portions 202, for example, in descending order of Y-coordinate value. In this case, the discharging head is repeatedly accelerated and decelerated along the Y directions, i.e., the main scanning directions, and the X directions, i.e., the sub-scanning directions. It should be noted that the arrows of FIG. 10 indicate a migration pathway of the discharging head. As shown in FIG. 10, according to the above method, the discharging head moves substantially straight from one pixel printing object portion 202 to another.

Further, according to the method for repeating movements alternately in the main scanning and sub-scanning directions, the discharging head repairs a defective part while moving along the main scanning directions and then moves along the sub-scanning directions. After the discharging head finishes moving along the sub-scanning directions, it repairs a defective part while again moving along the main scanning directions. The above method is thus a method for repeating movements alternately in the main scanning and sub-scanning directions. For example, assume, as shown in FIG. 11, that there are a plurality of pixel printing object portions 302 scattered about on a substrate 304. In this case, according to the above method, the discharging head repairs a pixel printing object portion 302 while moving only along the main scanning directions Y. When the discharging head finishes the repair, it moves only along the sub-scanning directions X without moving along the main scanning directions Y. Therefore, according to the above method, the discharging head is repeatedly accelerated and decelerated along the main scanning directions Y and the sub-scanning directions X. It should be noted that the arrows of FIG. 11 indicate a migration pathway of the discharging head. As shown in FIG. 11, according to the above method, the discharging head moves in a zigzag from one pixel printing object portion 302 to another.

### Citation List

Patent Literature 1

### Japanese Patent Application Publication, Tokukai, No. 2004-306617 A (Publication Date: Nov. 4, 2004)

Patent Literature 2

### Japanese Patent Application Publication, Tokukai, No. 2003-66218 A (Publication Date: Mar. 5, 2003)

### DISCLOSURE OF INVENTION

However, unfortunately, the conventional ink-discharging methods require a large amount of time for the discharging head to turn from a main scanning direction into the opposite main scanning direction. Further, in moving to an object of ink discharge, the discharge head changes in moving velocity so significantly that the apparatus is subjected to a large load. Moreover, an attempt to keep the precision of landing of ink results in an increase in time required for a repair process.

Specifically, since the X-Y plotter method, which is a conventional ink-discharging method, causes the discharging head to repair defective parts while moving over the defective parts in descending order of Y-coordinate value, the discharging head turns from a main scanning direction into the opposite main scanning direction without any regard for the defective part to which it moves next. For this reason, the X-Y plotter method requires a large amount of time for the discharging head to from a main scanning direction into the opposite main scanning direction. Meanwhile, the method for repeating movements alternately in the main scanning and sub-scanning directions causes the discharging head to move in a zigzag from one pixel printing object portion 302 to another, and as such, requires a very large amount of time for the discharging head to turn from a main scanning direction into the opposite main scanning direction.

Further, in order to cause ink to land onto an object of ink discharge with high precision, the discharging head needs to discharge ink with little acceleration or deceleration. Therefore, the above two methods both require the velocity of the discharging head to be constant immediately before printing. This forces the discharging head to repeat movements accompanied by acceleration or deceleration, i.e., movements accompanied by loads. Furthermore, it takes time to cause the velocity to be constant. This results in a lengthening of processing time.

The present invention has been made in view of the foregoing problems, and it is an object of the present invention to provide an ink-discharging apparatus whose discharging head can turn from a main scanning direction into the opposite main scanning direction in a short period of time in moving from one target of ink discharge to another. It is another object of the present invention to provide an ink-discharging apparatus capable of accurately discharging ink at a target of discharge.

In order to solve the foregoing problems, an ink-discharging apparatus of the present invention is an ink-discharging apparatus including ink-discharging means. The ink-discharging means is a component, capable of moving relative to a medium along main scanning directions and sub-scanning directions so as to discharge ink at a group of targets of ink discharge scattered about on the medium, which moves at a constant velocity along the main scanning directions. The group of targets of ink discharge includes (i) a plurality of targets of first-direction discharge at which the ink-discharging means discharges ink by identical scanning in a first one of the main scanning directions and (ii) a plurality of targets of second-direction discharge at which the ink-discharging means discharges ink by identical scanning in a second one of the main scanning directions opposite to the first direction. The ink-discharging means takes longer to move from one target of first-direction discharge to another along the main-scanning directions than along the sub-scanning directions and takes longer to move from one of the targets of second-direction discharge to another along the main-scanning directions than along the sub-scanning directions. The ink-discharging means takes longer to move from the last one of the targets of first-direction discharge to the first one of the targets of second-direction discharge along the sub-scanning directions than along the main scanning directions, the last target of first-direction discharge being a target of first-direction discharge that the ink-discharging means scans last among the targets of first-direction discharge, the first target of second-direction discharge being a target of second-direction discharge that the ink-discharging means scans first among the targets of second-direction discharge. The ink-discharging means starts to move along the sub-scanning directions toward the first target of second-direction discharge in starting to move from the last target of first-direction discharge to the first target of second-direction discharge.

According to the foregoing invention, in starting to move from the last target of first-direction discharge to the first target of second-direction discharge, the ink-discharging means starts to move along the sub-scanning directions toward the first target of second-direction discharge, and therefore can turn from a main scanning direction into the opposite main scanning direction in a short period of time.

Further, the ink-discharging apparatus according to the present invention is preferably arranged such that the ink-discharging means turns from the first main scanning direction into the second main scanning direction in accordance with a position of the last target of first-direction discharge along the main scanning directions and a position of the first target of second-direction discharge along the main scanning directions.

The turning of the ink-discharging means in accordance with the position of the last target of first-direction discharge along the main scanning directions and the position of the first target of second-direction discharge along the main scanning directions enables a reduction in distance that the ink-discharging means moves, thus enabling a further reduction in time required for the ink-discharging means to turn from a main scanning direction into the opposite main scanning direction.

Further, the ink-discharging apparatus according to the present invention is preferably arranged such that when the first target of second-direction discharge is located farther in the first main scanning direction than the last target of first-direction discharge, the ink-discharging means turns from the first main scanning direction into the second main scanning direction in accordance with a position of the first target of second-direction discharge.

Further, the ink-discharging apparatus according to the present invention is preferably arranged such that when the last target of first-direction discharge is located farther in the first main scanning direction than the first target of second-direction discharge, the ink-discharging means turns from the first main scanning direction into the second main scanning direction in accordance with a position of the last target of first-direction discharge.

The foregoing arrangement enables a reduction in time required for the ink-discharging means to move along the main scanning directions in turning from a main scanning direction into the opposite main scanning direction, thus enabling a further reduction in time required for the ink-discharging means to turn from a main scanning direction into the opposite main scanning direction.

Further, the ink-discharging apparatus according to the present invention is preferably arranged such that the ink-discharging means turns from the first main scanning direction into the second main scanning direction at a turning position determined in accordance with characteristics of acceleration and deceleration along the main scanning directions.

This enables the ink-discharging means to move to the first target of second-direction discharge while moving at a constant velocity along the main scanning directions, thus enabling more accurate discharge of ink at the first target of negative-direction discharge.

For a fuller understanding of the nature and advantages of the invention, reference should be made to the ensuing detailed description taken in conjunction with the accompanying drawings.

### BRIEF DESCRIPTION OF DRAWINGS

FIG. 1

FIG. 1 is a pattern diagram showing a process by which the ink-discharging apparatus discharges ink onto (a) vertically long objects of ink discharge and (b) horizontally long objects of ink discharge according to an ink discharge control method.

FIG. 2

FIG. 2 is a block diagram showing components of the ink-discharging apparatus.

FIG. 3

FIG. 3 is a pattern diagram showing (a) positions that nozzles take when a discharging head of the ink discharging apparatus is not inclined and (b) positions that the nozzles take when the discharging head has been inclined.

FIG. 4

FIG. 4 is a pattern diagram showing positions that the nozzles take (a) when the ink-discharging apparatus repairs two adjacent pixels at once and (b) when the ink-discharging apparatus repairs three adjacent pixels at once.

FIG. 5

FIG. 5 is a flow chart showing discharge of ink by an ink-discharging apparatus according to the present embodiment.

FIG. 6

FIG. 6 is a flow chart detailing Step 1 according to the present embodiment.

FIG. 7

FIG. 7, showing an embodiment of the present invention, is a pattern diagram showing an order of discharge of ink onto objects of ink discharge by an ink-discharging apparatus according to an ink discharge control method.

FIG. 8

FIG. 8 is a pattern diagram showing how an ink-discharging section according to an embodiment of the present invention works and periods of time during which the ink-discharging section to moves along sub-scanning and main scanning directions.

FIG. 9

FIG. 9 is a pattern diagram showing an order in which defective parts are corrected according to a conventional method for alternate scanning in main scanning and sub-scanning directions.

FIG. 10

FIG. 10 is a pattern diagram showing an order in which defective parts are corrected according to a conventional X-Y plotter method.

FIG. 11

FIG. 11 is a pattern diagram showing an order in which defective parts are corrected according to a conventional method for alternate scanning in main scanning and sub-scanning directions.

### REFERENCE NUMERALS

1 Pixel

2a, 2c Pixel printing object portion (target of positive-direction discharge, target of first-direction discharge)

2a-2 Last target of positive-direction discharge (last target of first-direction discharge)

2b Pixel printing object portion (target of negative-direction discharge, target of second-direction discharge)

2b-1 First target of negative-direction discharge (first target of second-direction discharge)

2b-2 Last target of negative-direction discharge (last target of second-direction discharge)

2c-1 First target of positive-direction discharge

4 Substrate

10 Information input section

11 Processing section

12 Data input section

20 Discharging head (ink-discharging means)

P2 Turning position

### DESCRIPTION OF EMBODIMENTS

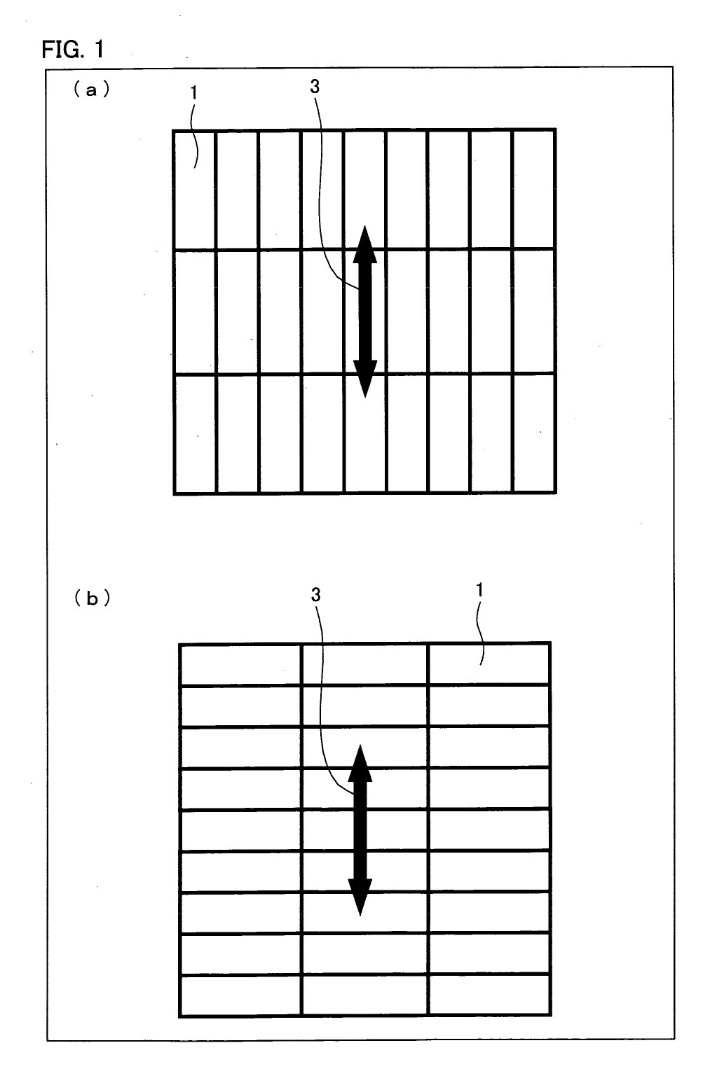

One embodiment of the present invention is described below with reference to FIGS. 1 through 8. However, the present invention is not limited to this.

An ink-discharging apparatus according to the present invention is an ink-discharging apparatus including ink-discharging means. The ink-discharging means is a component, capable of moving relative to a medium along main scanning directions and sub-scanning directions so as to discharge ink at a group of targets of ink discharge scattered about on the medium, which moves at a constant velocity along the main scanning directions. The group of targets of ink discharge includes (i) a plurality of targets of first-direction discharge at which the ink-discharging means discharges ink by identical scanning in a first one of the main scanning directions and (ii) a plurality of targets of second-direction discharge at which the ink-discharging means discharges ink by identical scanning in a second one of the main scanning directions opposite to the first direction. The ink-discharging means takes longer to move from one target of first-direction discharge to another along the main-scanning directions than along the sub-scanning directions and takes longer to move from one of the targets of second-direction discharge to another along the main-scanning directions than along the sub-scanning directions. The ink-discharging means takes longer to move from the last one of the targets of first-direction discharge to the first one of the targets of second-direction discharge along the sub-scanning directions than along the main scanning directions, the last target of first-direction discharge being a target of first-direction discharge that the ink-discharging means scans last among the targets of first-direction discharge, the first target of second-direction discharge being a target of second-direction discharge that the ink-discharging means scans first among the targets of second-direction discharge. The ink-discharging means starts to move along the sub-scanning directions toward the first target of second-direction discharge in starting to move from the last target of first-direction discharge to the first target of second-direction discharge. The following describes the ink-discharging apparatus.

The first main scanning direction means one of the main scanning directions along which the ink-discharging means moves. Furthermore, the first and second main scanning directions are opposite main scanning directions. For convenience of explanation, the present embodiment assumes that the first main scanning direction is a positive main scanning direction and the second main scanning direction is a negative main scanning direction. However, the opposite may be also true.

The following description assumes that the main scanning directions are directions of a Y-coordinate axis and the sub-scanning directions are directions of an X-coordinate axis. Further, one embodiment of the present invention is described by way of an example of repair of CF defective pixels where those to-be-corrected pixel portions of a CF panel which have been scattered about on a substrate are filled in with jets of ink. For this reason, three colors of ink, namely red (R) ink, green (G) ink, and blue (B) ink are used, and parts to be corrected are substantially rectangular regions corresponding to pixels 1. The roughly rectangular regions may be vertically long as shown in (a) of FIG. 1 or horizontally long as shown in (b) of FIG. 1, because of the scanning directions of the ink-discharging apparatus, depending on the placement of a panel substrate. The present invention can deal with both cases. It should be noted, in (a) and (b), that the arrows 3 indicate the scanning directions of the ink-discharging apparatus.

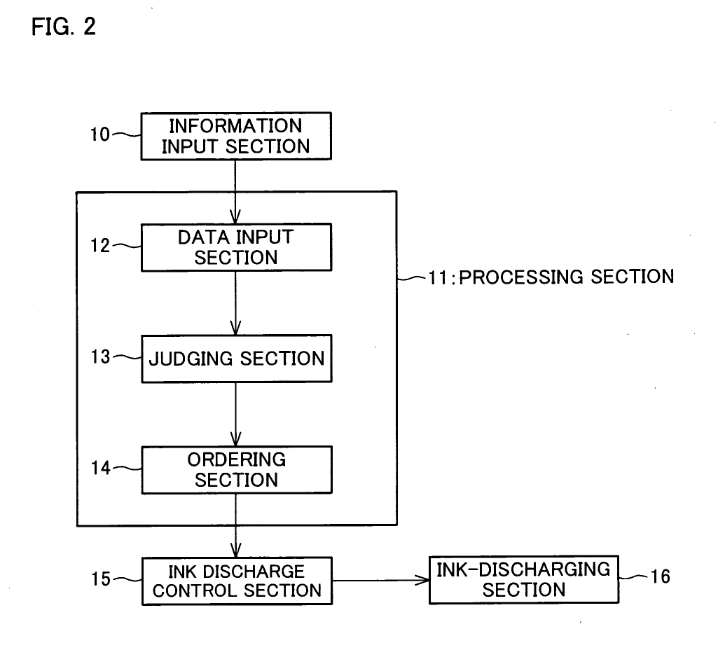

First, components of the ink-discharging apparatus according to the present invention are described with reference to FIG. 2. The ink-discharging apparatus according to the present invention has an information input section 10, a processing section 11, an ink discharge control section 15, and an ink-discharging section 16. Furthermore, the processing section 11 has a data input section 12, a judging section 13, and an ordering section 14.

In the ink-discharging apparatus of the present invention, the ink-discharging section 16 can move relative to a medium (not shown). In other words, the ink-discharging apparatus according to the present invention may be arranged such (1) that the ink-discharging section 16 can be moved by a publicly-known moving member relative to the medium with the medium fixed by a publicly-known fixing member, (2) that a medium can be moved by a publicly-known moving member relative to the ink-discharging section 16 with the ink-discharging section 16 fixed by a publicly-known fixing member, or (3) that both the ink-discharging section 16 and the medium can be moved by a publicly-known moving member. It should be noted that the fixing member and the moving member are not particularly limited in their specific arrangements. It is possible to appropriately employ arrangements publicly known in the technical field of the present invention.

The movement of the ink-discharging section 16 relative to the medium is controlled by the ink discharge control section 15. For example, in the above arrangement (1), the movement of the ink-discharging section 16 by the moving member is controlled. In the above arrangement (2), the movement of the medium by the moving member is controlled. In the above arrangement (3), the movement of both the ink-discharging section 16 and the medium by the moving member is controlled. It should be noted that how the movement is specifically controlled and how the positioning of the ink-discharging section 16 in relation to the medium is controlled will be described later with reference to the above arrangement (1).

In the ink-discharging apparatus of the present embodiment, the information input section 10 receives, e.g., information concerning objects of ink discharge. The information input section 10 sends the data input section 12, e.g., information concerning a plurality of scattered objects of ink discharge. The information is not particularly limited as long as it is information for determining an order of discharge of ink onto a plurality of objects of ink discharge scattered about on a substrate. An example is information on the positions of objects of ink discharge on a CF panel. Further, the information input section 10 can be arranged as known publicly, and as such, is not particularly limited. For example, the information input section 10 may be arranged to recognize objects of ink discharge with use of a camera-equipped image recognition apparatus or the like, to obtain information on the positions the objects of ink discharge, and to send the information to the data input section 12.

The data input section 12 receives the information from the information input section 10. The information thus received is sent to the judging section 13. The data input section 12 is not particularly limited, and as such, can be appropriately arranged as known publicly.

The judging section 13 determines, in accordance with the information sent from the data input section 12, a group of targets of ink discharge at which ink is discharged. The group of targets of ink discharge includes a plurality of targets of positive-direction discharge and a plurality of targets of negative-direction discharge as shown below.

First, the judging section 13 determines a target of ink discharge at which ink is discharged first in a first one of the main scanning directions, and the target of ink discharge serves as a starting point. The first main scanning direction is referred to as a positive main scanning direction. There is no particular limitation on how the starting point is selected. For example, it is possible to select, as the starting point, an object of ink discharge largest or smallest in Y-coordinate value from among a plurality of objects scattered about on a substrate. Alternatively, it is possible to select, as the starting point, an object of ink discharge located closest to the ink-discharging section 16.

Further, the judging section 13 determines, in accordance with the information sent from the data input section 12, targets of positive- and negative-direction discharge that are to be included in a group of targets of ink discharge. For example, in cases where a given object of ink discharge is a first target of ink discharge, the judging section 13 (i) calculates amounts of time required for the ink-discharging section 16 to move from the first target of ink discharge to another target of ink discharge along the main scanning directions (such an amount of time being hereinafter referred to appropriately as “Yt”) and along the sub-scanning directions (such an amount of time being hereinafter referred to appropriately as “Xt”), and (ii) judges, as candidates for the next target of ink discharge, objects of ink discharge that satisfy Xt≦Yt.

Further, in cases where the judging section 13 defines a given object of ink discharge as a first target of ink discharge in accordance with the information sent from the data input section 12, the judging section 13 (i) calculates, in order of nearness in distance from the first target of ink discharge, Yt and Xt required for the ink-discharging section 16 to move from the first target of ink discharge to another target of ink discharge, (ii) judges whether or not Xt≦Yt, and (iii) chooses, as the next target of ink discharge, an object of ink discharge that satisfies Xt≦Yt. Next targets of ink discharge thus determined in order of the positive main scanning direction serve as targets of positive-direction discharge.

From among the candidates for the next target of ink discharge, the ordering section 14 chooses, as the next target of ink discharge, an object of ink discharge nearest in time from the first target of ink discharge. In cases where the judging section 13 judges objects of ink discharge in order of nearness in distance from the first target of ink discharge, the ordering section 14 chooses, as a candidate for the next target of ink discharge, an object of ink discharge that has been judged as the first candidate for the next target of ink discharge. Therefore, in this case, the ordering section 14 can be omitted.

Next, the judging section 13 (i) calculates, in order of nearness in distance from the last target of positive-direction discharge that the ink-discharging section 16 scans last among the targets of positive-direction discharge, Yt and Xt required for the ink-discharging section 16 to move from the first target of ink discharge to another target of ink discharge, (ii) judges whether or not Xt≧Yt, and (iii) judges, as candidates for the first target of negative-direction discharge, objects of ink discharge that satisfy Xt≧Yt. Then, from among the candidates for the first target of negative-direction discharge, the ordering section 14 chooses, as the first target of negative-direction discharge, a candidate located closest to the last target of positive-direction ink discharge.

Furthermore, assume that the main scanning direction has been changed from the positive main scanning direction to a negative main scanning direction opposite to the positive main scanning direction and the first target of negative-direction discharge is a starting point. Then, as with the procedure for determining the targets of positive-direction discharge, the judging section 13 determines next targets of negative-direction discharge, thus determining a plurality of targets of negative-direction discharge. Further, in cases where there exist objects of ink discharge, the ordering section 14 again determines the last target of positive-direction discharge and the first target of negative-direction discharge.

The ink discharge control section 15 can move the ink-discharging section 16 with respect to objects of ink discharge in order of ink discharge, and can incline the ink-discharging section 16 to the main scanning or sub-scanning directions with the ink-discharging section 16 facing objects of ink discharge. The case where the ink-discharging section 16 is inclined will be described later. Further, the ink discharge control section 15 can both move the ink-discharging section 16 and move a substrate including objects of ink discharge, and as such, is not particularly limited.

When the ink-discharging section 16 starts to move from the last target of positive-direction discharge to the first target of negative-direction discharge, the ink discharge control section 15 causes the ink-discharging section 16 to start to move along the sub-scanning directions. This causes the ink-discharging section 16 to also move along the sub-scanning directions in turning from a main scanning direction into the opposite main scanning direction, thus enabling a reduction in time required for the ink-discharging section 16 to turn, in comparison with the conventional procedure in which the discharging head moves along the sub-scanning directions after finishing moving along the main scanning directions.

It is preferable that the ink-discharging section 16 turn from a main scanning direction into the opposite main scanning direction in accordance with the position of the last target of positive-direction discharge along the main scanning directions and the position of the first target of negative-direction discharge along the main scanning directions.

Specifically, when the first target of negative-direction discharge is located farther in the positive main scanning direction than the last target of positive-direction discharge, the ink-discharging section 16 turns from the positive main scanning direction into the negative main scanning direction in accordance with the position of the first target of negative-direction discharge. That is, the ink-discharging section 16 turns from the first target of negative-direction discharge. Alternatively, when the last target of positive-direction discharge is located farther in the positive main scanning direction than the first target of negative-direction discharge, it is preferable that the ink-discharging section 16 turn from the positive main scanning direction into the negative main scanning direction in accordance with the position of the last target of positive-direction discharge. That is, the ink-discharging section 16 turns from the last target of positive-direction discharge. This enables a further reduction in time required for the ink-discharging section 16 to turn.

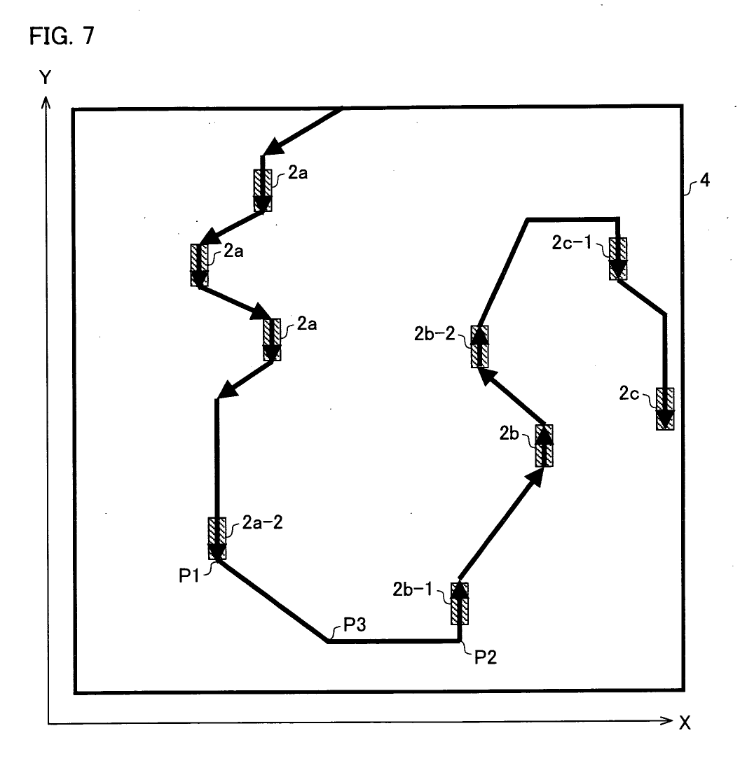

Further, it is preferable that the ink-discharging section 16 turn from the positive main scanning direction into the negative main scanning direction at a turning position determined in accordance with the characteristics of acceleration and deceleration along the main scanning directions. That is, the ink-discharging section 16 moves with acceleration or deceleration. The ink-discharging section 16 turns from a main scanning direction into the opposite main scanning direction (i.e., from the positive main scanning direction into the negative main scanning direction, or vice versa) at a turning position determined in accordance with the characteristics of acceleration and deceleration with which the ink-discharging section 16 accelerates or decelerates, thereby enabling a further reduction in time for turning. Details will be described below with reference to FIG. 7.

Further, the ink discharge control section 15 can cause pre-oscillation of the ink-discharging section 16. The term “pre-oscillation” here means that ink contained in the ink-discharging section 16 is stirred before the ink is discharged. This makes it possible to inhibit the ink from partially changing in viscosity due to volatilization of a solvent of the ink, thus making it possible to reduce a change in discharge state of the ink.

The ink-discharging section 16 discharges ink onto an object of ink discharge. The ink-discharging section 16 is not particularly limited, and as such, can be appropriately arranged as known publicly. It is preferable that the amount of ink that is discharged from the ink-discharging section 16, based on the area of a target of ink discharge, the thickness of a film formed by the ink discharged, the properties of the ink, and the percentage of a film remaining, be calculated by Eq. (8) as follows:

Amount of Ink Discharged=Area of Object of Ink Discharge×Film Thickness/Percentage of Film Remaining (Eq. 8).

Further, it is preferable that the number of droplets that are discharged from each nozzle assigned to an object of ink discharge, based on the volume of a single droplet that is discharged from the nozzle, be calculated by Eq. (9) as follows:

Number of Droplets=Amount of Ink Discharged/Volume of Droplet (Eq. 9).

Each nozzle for an object of discharge is allotted the number of droplets thus calculated. The allotment of the number of droplets to each nozzle is controlled, for example, in accordance with the state of wettability with respect to the base of an object of ink discharge and the orientation of a column of head-equipped nozzles with respect to a scanning direction. For example, each nozzle is equally allotted the number of droplets, or differently allotted the numbers of droplets in consideration of the scanning direction.

In cases where the ink-discharging section 16 is inclined by the ink discharge control section 15 to the main scanning or sub-scanning directions while facing objects of ink discharge, it becomes possible to reduce the distance between one nozzle and another along the sub-scanning directions. This makes it possible to discharge ink onto an identical object of ink discharge with use of a larger number of nozzles. The distance between one nozzle and another can be determined by the angle of inclination of the ink-discharging section 16. It should be noted that the angle of inclination of the ink-discharging section 16 is not particularly limited, and as such, can be selected. For example, the angle of inclination can be set in accordance with the size of an object of ink discharge or, in particular, the length of an object of ink discharge along the directions of the X-coordinate axis and the size of a droplet of ink.

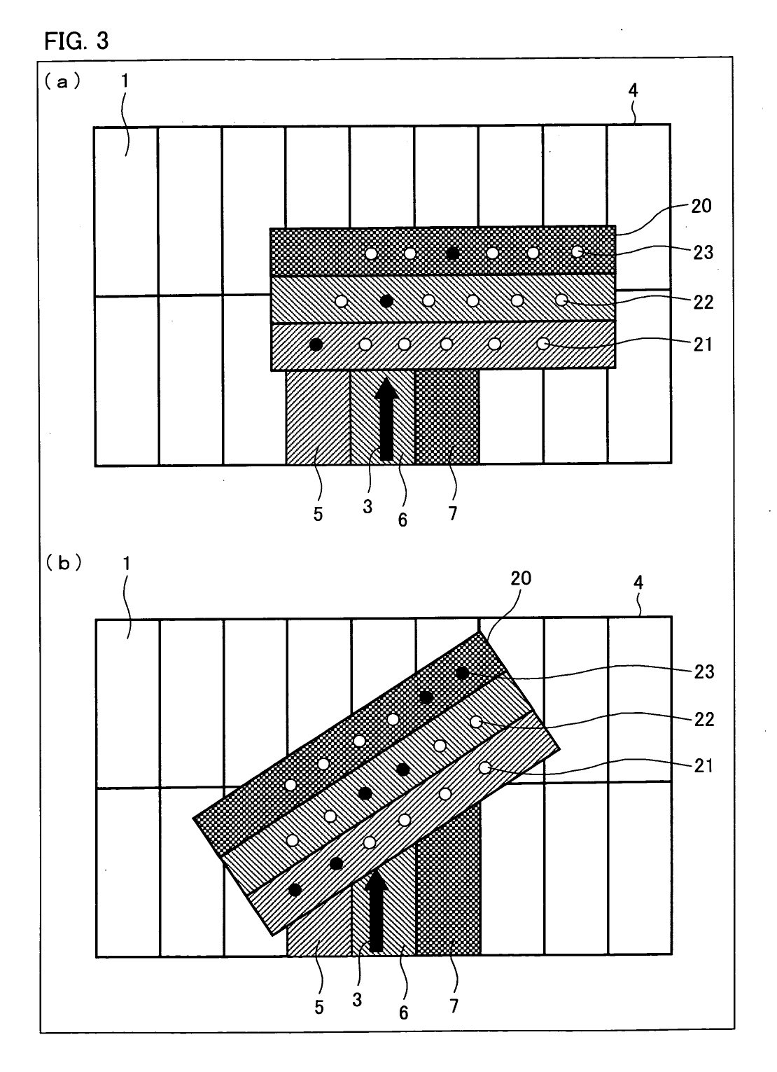

For example, as shown in FIG. 3, the ink-discharging apparatus and an ink discharge control method of the present embodiment can incline the ink-discharging section 16 to the main scanning or sub-scanning directions with the ink-discharging section 16 facing objects of ink discharge. The following the dispositions of nozzles before and after an inclination of the ink-discharging section 16 to the main scanning or sub-scanning directions. It should be noted, in FIG. 3, that the discharging head 20 corresponds to the ink-discharging section 16.

As shown in (a) of FIG. 3, the discharging head 20, which has nozzles 21, 22, and 23, is disposed in such a way as to face a substrate 4. It is assumed here that the discharging head 20 discharges ink while moving in the direction of an arrow 3. Further, the substrate 4 has a plurality of pixels 1. Among the pixels 1, pixels 5, 6, and 7 are pixels onto which red (R) ink, green (G) ink, and blue (B) ink are discharged, respectively. The discharging head 20 has a plurality of nozzles 21, a plurality of nozzles 22, and a plurality of nozzles 23 so as to discharge red (R) ink, green (G) ink, and blue (B) ink, respectively. Among the nozzles, nozzles that discharge ink onto the pixels 5, 6, and 7 are indicated by filled circles. That is, as shown in (a) of FIG. 3, the pixel 5 has ink discharged thereonto by a single nozzle 21. Similarly, the pixel 6 has ink discharged thereonto by a single nozzle 22, and the pixel 7 has ink discharged thereonto by a single nozzle 23.

Further, as shown in (b) of FIG. 3, the discharging head 20 can be inclined to the main scanning or sub-scanning directions while facing the substrate 4. As shown in (b) of FIG. 3, an inclination of the discharging head 20 makes it possible to discharge ink onto the pixel 5 with use of two nozzles 21, to discharge ink onto the pixel 6 with use of two nozzles 22, and to discharge ink onto the pixel 7 with use of two nozzles 23. Even in the case of low wettability of ink with respect to the substrate 4, a target of ink discharge can be filled with the ink through discharge of the ink onto a wider region within an object of ink discharge.

In cases where the discharging head 20 is inclined as described above, e.g., inclined fixedly at 80 degrees, the distance between adjacent droplets of ink is constant. Therefore, the number of droplets to be discharged is adjusted for each nozzle, and the amount of ink to be dropped to fill in a defective pixel is determined. It should be noted that when a discharging head 20 of an ink-discharging apparatus having a nozzle interval equivalent to 150 dpi is inclined at approximately 80 degrees, the distance between one nozzle and another along the sub-scanning directions is approximately 30 μm. On the assumption that the width of a pixel is 100 μm, the same pixel can be subjected to printing through discharge of ink from at least two nozzles. It is also possible that the total drop amount required to fill in a defective pixel may be secured by controlling the number of droplets that are discharged from the two nozzles.

For example, in cases where the width of a pixel 1 in a direction perpendicular to the direction of the arrow 3 is wide as shown in (b) of FIG. 1 and the width is 300 μm, nine nozzles fall within the width of the pixel 1. In this case, even if one of the nine nozzles is defective, the remaining eight nozzles can be used to discharge a desired drop amount of ink.

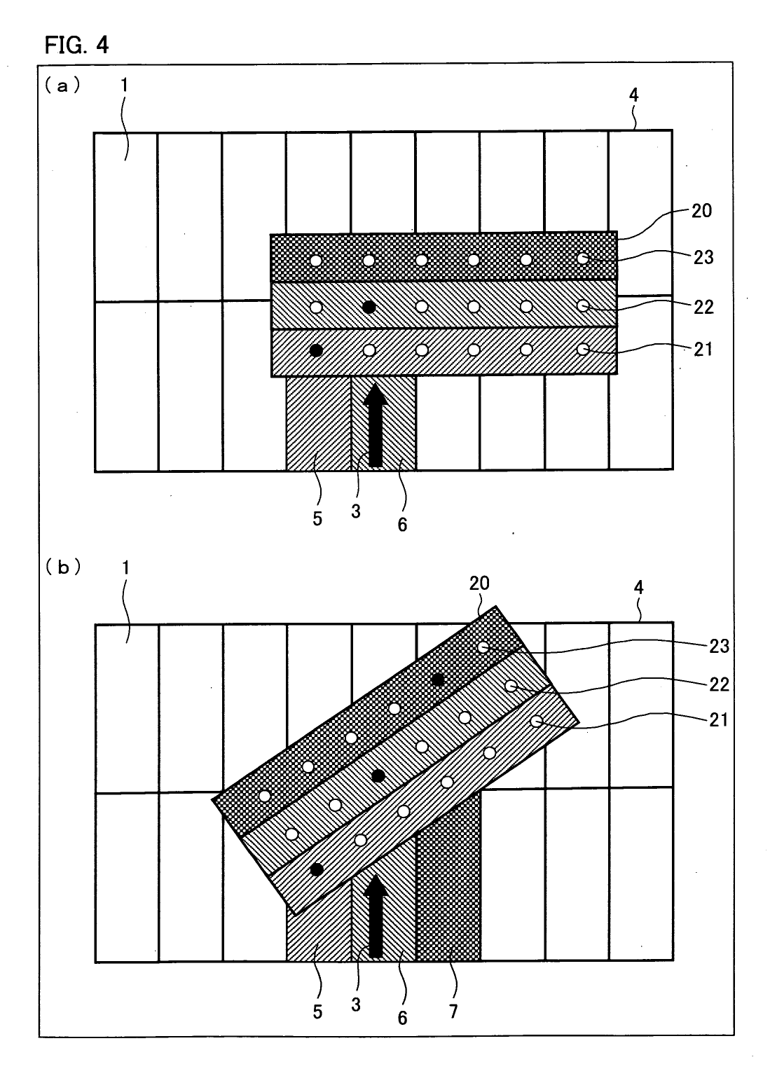

Further, as shown in FIG. 4, the use of the ink-discharging apparatus of the present embodiment makes it possible to repair defective pixels, e.g., to correct a unicolor defective pixel such as a blank in pixel color among RGB pixels, to simultaneously correct two adjacent defective pixels, such as RG, GB, or BR, caused by leakage of color between the pixels due to foreign material such as dust, and to simultaneously correct three adjacent defective pixels, such as RGB, GBR, or BRG, caused by leakage of color among the pixels due to foreign material such as dust.

The virtual interval of ink discharge along the sub-scanning directions can be narrowed by moving discharging heads 20 of ink-discharging apparatuses for different colors toward one another, positioning a nozzle of each discharging head 20 at a target of ink discharge with respect to at least the main scanning directions, and inclining the discharging head 20 as mentioned above. Further, in order to be able to repair adjacent defective pixels with use of different colors of ink, it is possible to finely adjust the nozzle position of a discharging head 20 in accordance with the positions of the adjacent pixels and repair the defective pixels during identical scanning with use of a plurality of different inks.

For example, as shown in FIG. 4, the ink-discharging apparatus of the present embodiment can repair two adjacent pixels during identical scanning. It should be noted, in (a) and (b) of FIG. 4, that the discharging head 20 corresponds to the ink-discharging section 16. In this case, it becomes possible to repair the adjacent pixels 5 and 6 with use of nozzles 21 and 22, respectively. Further, as shown in (b) of FIG. 4, the ink-discharging apparatus and the ink discharge control method of the present embodiment can repair three adjacent pixels during identical scanning. In this case, an inclination of the discharging head 20 makes it possible to repair the adjacent pixels 5, 6, and 7 with use of nozzles 21, 22, and 23, respectively.

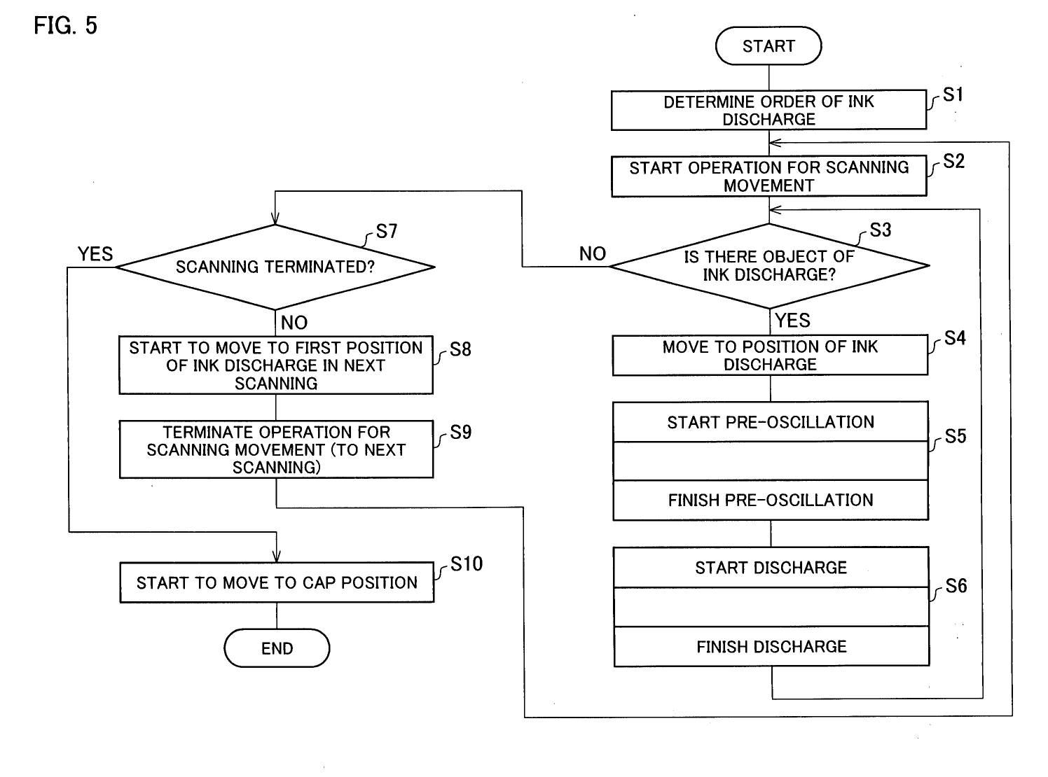

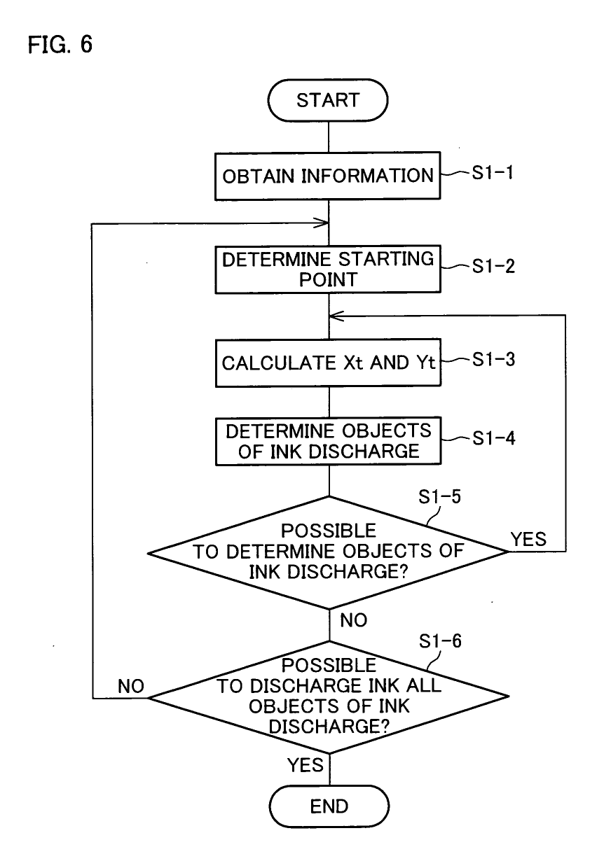

With reference to FIG. 5, the following describes steps of a procedure for operating and a method for controlling an ink-discharging apparatus according to the present embodiment. FIG. 5 is a flow chart, showing the discharge of ink by an ink-discharging apparatus according to the present embodiment, which is constituted by Steps 1 through 10 (“Step” being hereinafter referred to appropriately as “S”). Further, FIG. 6 is a flow chart showing Steps S1-1 through S1-6, which constitute Step S1 of FIG. 5. First, Step S1 is described with reference to FIG. 6.

(Step S1)

Step S1 is a step of determining a group of targets of ink discharge at which ink is discharged by a discharging head of the present embodiment. Step S1 includes Steps S1-1 through S1-6.

(Step S1-1)

First, the information input section 10 obtains information for determining an order of discharge of ink onto a plurality of objects of ink discharge scattered about on a medium. Contained in the input information are the X-Y coordinate value of each of the objects of ink discharge on the substrate, the lengths of the object of ink discharge along the directions of the X-coordinate axis and along the directions of the Y-coordinate axis (when the object of ink discharge is rectangular), and the velocities at which the ink-discharging section 16 moves along the directions of the X-coordinate axis and along the directions of the Y-coordinate axis. Furthermore, in discharging ink onto the object of ink discharge, it is preferable to give consideration to the amount of time required for the ink-discharging section 16 to stop when arriving at the X-coordinate value of a position of ink discharge, the distance that the ink-discharging section 16 moves along the directions of the Y-coordinate axis within the period of time required for the stoppage, and the acceleration and deceleration with which the ink-discharging section 16 moves along the directions of the X-coordinate axis, in addition to the length that the ink-discharging section 16 moves along the directions of the Y-coordinate axis (the length of the object of ink discharge along the directions of the Y-coordinate axis).

Now, assume that R1 is a set of objects of ink discharge whose order of ink discharge has not yet been decided and P(i), where i=1˜n (where n is the number of objects of ink discharge) are elements of the set R1. Also, assume that R2 is a set of objects of ink discharge whose order of ink discharge has been decided and onto which the discharging head 20 (ink-discharging section 16) can discharge ink while moving in one of the directions of the Y-coordinate axis and PP(j)(k), where j=1˜s and k=k˜m, are elements of the set R2. In cases where a movement made by the discharging head 20 between a point of time where the discharging head 20 starts to move in one of the directions of the Y-coordinate axis and a point of time where the discharging head 20 changes the direction in which it moves is defined as a “single movement in a main scanning direction”, j is the number of movements of the discharging head 20 discharging ink onto PP(j)(k), and s is the total number of movements. Further, k is the order of ink discharge of objects of ink discharge onto which ink is discharged during the movements defined by j, and m is the number of objects of ink discharge onto which ink is discharged during the movements defined by j. It should be noted that j and k each have a default value of 1.

(Step S1-2)

Next, the judging section 13 determines a starting point in accordance with the input information (S1-2). In S1-2, targets of positive- or negative-direction discharge in either of the main scanning directions are determined. The starting point is determined, for example, by reordering objects of ink discharge in accordance with the Y-coordinate value of each of the objects of ink discharge on the substrate. In this case, for example, it is possible to reorder the data in descending or ascending order of Y-coordinate value. In cases where the main scanning direction is a minus direction of the Y-coordinate axis, the objects of ink discharge are arranged in descending order of Y-coordinate value. Alternatively, in cases where the main scanning direction is a plus direction of the Y-coordinate axis, the objects of ink discharge are arranged in ascending order of Y-coordinate value. Further, the objects of ink discharge may be reordered in order of nearness in direct distance from the ink-discharging section 16. There are various criteria for reordering the objects of ink discharge, and there is no particular limitation thereon.

Now that the set R1 is a set including all of the objects of ink discharge thus reordered, the objects of ink discharge can be reordered as elements P(i), where i=1˜n (where n is the number of objects of ink discharge), of the set R1. Then, the first element P(1) is selected from the set R1, removed from the set R1, and newly put into the set R2. Thus, the set R1 includes elements P(i), where i=2˜n, and the set R2 includes an element PP(j)(k)=P(1), which serves as a starting point.

(Step S1-3)

Next, the judging section 13 selects candidates for targets of ink discharge. Specifically, the judging section 13 calculates amounts of time required for the ink-discharging section 16 to move from the element PP(j)(k) to each of the objects of ink discharge, i.e., to each of the elements P(i), where i=2˜n, of the set R1 along the directions of the X-coordinate axis and along the directions of the Y-coordinate axis. Then, the judging section 13 judges, as candidates for targets of ink discharge, those elements in the set R1 which only require a shorter or equal amount of time for the ink-discharging section 16 to move along the directions of the X-coordinate axis than along the directions of the Y-coordinate axis.

It should be noted here that there is no particular limitation on the order in which the objects of ink discharge, i.e., the elements of the set R1 are judged. They may be judged, for example, in order of nearness in distance from the starting point. In this case, it is not necessary to judge, for each of the objects of ink discharge, whether or not it satisfies Xt≦Yt, and the first object of ink discharge to satisfy Xt≦Yt is chosen as the next target of ink discharge.

The following describes methods for calculating amounts of time required for the ink-discharging section 16 to move from the element PP(j)(k) to each of the elements P(i) of the set R1 along the directions of the X-coordinate axis and along the directions of the Y-coordinate axis.

First, a method for calculating an amount of time required for the ink-discharging section 16 to move along the directions of the Y-coordinate axis is described. Let is be assumed that Yt (second) is the amount of time required for the ink-discharging section 16 to move along the directions of the Y-coordinate axis, that Y₁ (mm) is the distance that the ink-discharging section 16 moves along the directions of the Y-coordinate axis, and that a (mm/second) is the constant moving velocity at which the ink-discharging section 16 moves along the directions of the Y-coordinate axis. In this case, Yt is given by Eq. (1) as follows:

Yt=Y₁/a (Eq. 1).

Next, a method for calculating an amount of time required for the ink-discharging section 16 to move along the directions of the X-coordinate axis is described. A movement along the directions of the X-coordinate axis includes four types of process, namely acceleration, constant-velocity movement, deceleration, and stoppage. If Xt is the amount of time required for the ink-discharging section 16 to move along the directions of the X-coordinate axis, then Xt is the sum of time required for the four types of process, namely acceleration, constant-velocity movement, deceleration, and stoppage. Therefore, the following shows amounts of time respectively required for the processes. The term “stoppage” here means a process by which the ink-discharging section 16 comes to rest with respect to the directions of the X-coordinate axis after finishing deceleration.

First, let is be assumed that d₁, d₂, and c (second) are the amounts of time required for acceleration, deceleration, and stoppage, respectively, and that X₂ (mm) is the distance that the ink-discharging section 16 moves along the directions of the X-coordinate coordinate at the time of acceleration and deceleration. In this case, if X₁ is the distance that the ink-discharging section 16 moves along the directions of the X-coordinate axis, the distance X₃ that the ink-discharging section 16 moves at the constant velocity is given by Eq. (2) as follows:

X₃=X₁−2×X₂ (Eq. 2).

In this case, if b (mm/second) is the constant velocity at which the ink-discharging section 16 moves, then the period of time d₃ during which the ink-discharging section 16 moves at the constant velocity is given by Eq. (3) as follows:

d₃=(X₁−2×X₂)/b (Eq. 3).

It should be noted here that Xt is the sum of time required for the four types of process, namely acceleration, constant-velocity movement, deceleration, and stoppage. Xt is given by Eq. (4) as follows:

Xt=d₃+d₁+d₂+c=(X₁−2×X₂)/b+(d₁+d₂)+c (Eq. 4).

Therefore, the judging section 13 selects, as candidates for targets of ink discharge, such elements in the set R1 that Yt and Xt, given by Eq. (1) and Eq. (5) respectively, satisfy Eq. (5):

Xt≦Yt (Eq. 5).

It should be noted that if K₁ (mm/second²) is the acceleration of movement along the directions of the X-coordinate axis, then the amount of time d₁ required for the velocity of movement along the directions of the X-coordinate axis to reach the constant velocity b (mm/second) is given by Eq. (6) as follows:

d₁=b/K₁ (Eq. 6).

Similarly, if K₂ (mm/second²) is the deceleration of movement along the directions of the X-coordinate axis, then the amount of time d₂ required for deceleration is given by Eq. (7) as follows:

d₂=b/K₂ (Eq. 7).

Further, the amount of time c required for stoppage can be obtained by actually moving the ink-discharging apparatus of the present invention and experimentally measuring the value.

Although the amounts of time required for movement along the directions of the X-coordinate axis and along the directions of the Y-coordinate axis have been calculated by Eq. (1) through Eq. (7) with use of the above variables, there is no limitation on how they are calculated. For example, it is possible to take other variables into consideration in calculating the amounts of time required for movement along the directions of the X-coordinate axis and along the directions of the Y-coordinate axis. Alternatively, it is also possible to omit any of the variables d₁, d₂, d₃, and c if it takes on a very small value.

(Step S1-4)

Next, from among the candidates for targets of ink discharge, the ordering section 14 selects, as the next starting point, an object of ink discharge nearest in time from the above starting point. In cases where the judging section 13 judges, in S1-3, objects of ink discharge in order of nearness in distance from the above starting point, the first object of ink discharge to satisfy Xt≦Yt is chosen as the next target of ink discharge. In this case, it is possible for the judging section 13 to determine the next target of ink discharge. This is how a target of positive- or negative-direction discharge, i.e., a target of ink discharge is determined.

(Step S1-5)

In cases where the set R1 includes a selectable element in S1-4, the element P(j) (where 2≦j≦n), which is an object of ink discharge, is selected, removed from the set R1, and added to the set R2 (PP(j)(k), (where k=k+1)). Then, the process proceeds to S1-3 with the element serving as a new starting point.

In cases where the set R1 does not include a selectable element in S1-4, there is no longer an object of ink discharge onto which ink can be discharged during a single movement in a main scanning direction. Therefore, the process proceeds to S1-6.

(Step S1-6)

In cases where all the objects of ink discharge have been chosen as elements of the set R2, the order in which all the scattered objects of ink discharge are processed is determined. Therefore, S1 is terminated. On the other hand, in cases where all the objects of ink discharge have not been chosen as elements of the set R2, the process returns to S1-2.

In determining a new starting point after returning to S1-2, the judging section 13 (i) calculates, in order of nearness in distance from the last target of positive-direction discharge that has been determined last in S1-4, Yt and Xt required for the ink-discharging section 16 to move from the first target of ink discharge to another target of ink discharge, (ii) judges whether or not Xt≧Yt, and (iii) judges, as the first target of negative-direction discharge, an object of ink discharge that satisfy Xt≧Yt. The satisfaction of Xt≧Yt by the first target of negative-direction discharge enables the ink-discharging section 16 to move to targets of positive- and negative-direction discharge widely scattered about on the medium.

Then, the first target of negative-direction discharge is chosen as a new starting point, and the ordering section 14 selects an object of ink discharge onto which the discharging head 20 can discharge ink while moving in a main scanning direction opposite to the previous main scanning direction. Further, the ordering section 14 also determines a turning position at which the discharging head 20 starts to move in a main scanning direction opposite to the previous main scanning direction. In so doing, the ordering section 14 adds to the value of j, which denotes the number of movements of the discharging head 20 along the main scanning directions, so that j=j+1. Further, the ordering section 14 resets k, which denotes the order of ink discharge, to the default value, so that k=1. As described above, Steps S1-2 through S1-6 are executed by the ordering section 14. The ordering section 14 determines an order of discharge of ink onto scattered objects of ink discharge in such a way as to minimize processing time required to sequentially discharge ink onto all the scattered objects of ink discharge.

(Step S2)

In order to move the head to a plurality of targets of positive- or negative-direction discharge scattered about on the medium, a scanning operation for moving the ink-discharging apparatus back and forth in the main scanning directions is started. Before the start of the scanning operation, the ink-discharging section 16 is covered with a cap. Before the scanning operation is started, the ink-discharging section 16 starts to move along the sub-scanning directions so as to move from the capping position of the head toward a target of ink discharge at which it discharges ink first.

(Step S3)

In S3, the judging section 13 judges whether or not there exists a target of ink discharge at which ink is to be discharged during a single movement in a main scanning direction. In cases there exists such a target of ink discharge, the ink-discharging section 16 is moved, in accordance with the order of ink discharge determined in S1, so as to discharge ink at the target of ink discharge on the medium. Then, the process proceeds to S4. Further, in cases where the medium does not have thereon a target of ink discharge at which ink is to be discharged during a single movement in a main scanning direction, the process proceeds to S7.

(Step S4)

In S4, the discharging head is moved to a target of ink discharge. The ink-discharging section 16 moves at a constant velocity along the main scanning directions, and starts to move along the sub-scanning directions in starting to move.

(Step S5)

Step S5 is a step of causing pre-oscillation of the discharging head with use of pre-oscillating means while the discharging head is moving to a target of ink discharge. Pre-oscillation brings about an improvement in ink viscosity inside of the discharging head or, in particular, in the vicinity of an ink-discharging outlet, thereby enabling stable discharge of ink. It is preferable that this step be executed for an improvement in ink viscosity. However, the step does not always needs to be executed, and as such, can be omitted.

(Step S6)

In S6, the ink discharge control section 15 and the ink-discharging section 16 discharge ink at targets of ink discharge in accordance with the number of movements along the main scanning directions in the order of elements included in the set R2 as determined in S1. As a result, in cases where there are a plurality of targets of ink discharge scattered about a substrate as shown later in FIG. 7, ink is discharged in the order indicated by the arrows of FIG. 7.

(Step S7)

In S7, the judging section 13 judges whether or not all the objects of ink discharge targeted during a single movement in a main scanning direction have been finished with ink discharge and all the movements along the main scanning directions have been finished as a result. In cases where there is still an object of ink discharge at which ink is to be discharged during a next single movement in a main scanning direction, the process proceeds to S8. In cases where all the objects of ink discharge on the medium have been finished with ink discharge, the process proceeds to S10.

(Step S8)

After or, preferably, immediately after completion of discharge of ink at the target of ink discharge at which ink was discharged at the end of each single movement in a main scanning direction, the ink-discharging section 16 starts to move along the sub-scanning directions toward the position of the first target of ink discharge in the next single movement in the opposite scanning direction. The movement of the ink-discharging section 16 along the sub-scanning directions in advance enables a reduction in time required to turn from a main scanning direction into the opposite main scanning direction.

(Step S9)

The ink-discharging section 16 is moved to a turning position at which it turns from a main scanning direction into the opposite main scanning direction. As a starting position for turning, such a position that the ink-discharging section 16 turns in the shortest period of time is chosen by making a comparison between the position of termination of discharge of ink onto the last object of ink discharge and the position of the first object of ink discharge in the next scanning.

(Step S10)

After completion of all the movements of the ink-discharging section 16 along the main scanning directions and completion of discharge of ink at all the groups of targets of ink discharge, the ink-discharging section 16 is moved to the cap position. The capping of the ink-discharging section 16 can prevents ink from thickening at the discharging head or, in particular, in the vicinity of the ink-discharging outlet.

FIG. 7 shows a route of discharge of ink by the ink-discharging apparatus of the present embodiment according to the ink discharge control method of the present embodiment. Scattered about on a substrate 4 are a plurality of pixel printing object portions, namely targets of positive-direction discharge 2a, a target of negative-direction discharge 2b, and a target of positive-direction discharge 2c. Further, the substrate 4 also has thereon the last target of positive-direction discharge 2a-2, the first target of negative-direction discharge 2b-1, the last target of negative-direction discharge 2b-2, and the first target of positive-direction discharge 2c-1.

The ink-discharging section discharges ink at the groups of targets of ink discharge determined in S1, while following the pathway indicated by the arrows in FIG. 7. In FIG. 7, the minus Y-axis direction corresponds to the positive main scanning direction, and the plus Y-axis direction corresponds to the negative main scanning direction. In FIG. 7, for convenience of explanation, the positive and negative main scanning directions have been set as above. However, the minus and plus Y-axis directions may be set as the negative and positive main scanning directions, respectively. Further, after starting to move, the ink-discharging section starts to move along the sub-scanning directions while moving in the positive main scanning direction, which is one of the main scanning directions.

At a point of time where the ink-discharging section has moved to the positive-direction target 2a, the ink-discharging section stops moving along the sub-scanning directions, and then discharges ink at the target of positive-direction discharge 2a while moving at a constant velocity in the positive main scanning direction. That is, the ink-discharging section discharges ink without a change in velocity. Therefore, the ink-discharging section can discharge ink at the target of positive-direction discharge with little acceleration and deceleration, and therefore can discharge ink highly precisely at the group of targets of ink discharge. Further, the ink-discharging section does not increase or decrease in moving velocity with respect to the main scanning directions, thus enabling a reduction in load on the ink-discharging means.

After discharging ink, the ink-discharging section starts to move along the sub-scanning directions so as to move to a target of positive-direction 2a at which ink is discharged next. After that, the ink-discharging section repeats the aforementioned operation to discharge ink at two targets of positive-direction 2a, and then discharges ink at the last target of positive-direction discharge 2a-2.

After discharging ink at the last target of positive-direction discharge 2a-2, the ink-discharging section starts move from the position P1 along the sub-scanning directions toward the first target of negative-direction discharge 2b-1 in starting to move from the last target of positive-direction discharge 2a-2 to the first target of negative-direction discharge 2b-1. That is, as shown in FIG. 7, the ink-discharging section according to the present embodiment, which has discharged ink at the last target of positive-direction discharge 2a-2, starts to move along the sub-scanning directions toward the first target of negative-direction discharge 2b-1, instead of simply moving in the positive main scanning direction. This enables the ink-discharging section to rapidly turn into the opposite main scanning direction. The phrase “to rapidly turn into the opposite main scanning direction” is rephrased to mean “to rapidly turn from the last target of positive-direction discharge 2a-2 to the first target of negative-direction discharge 2b-1”.

The amount of time Xt required for the ink-discharging section to move from the last target of positive-direction discharge 2a-2 to the first target of negative-direction discharge 2b-1 along the sub-scanning direction is not shorter than Yt. Therefore, first, based on the turning position P2, the movement of the ink-discharging section in the positive main scanning direction stops at the position P3. After that, the ink-discharging section moves only along the sub-scanning directions, i.e., in the plus direction of the X axis, arrives at the turning position P2, and stops moving along the sub-scanning directions. Then, the ink-discharging section starts to move in the negative main scanning direction, and arrives at the first target of negative-direction discharge 2b-1.

In FIG. 7, the turning position P2 of the ink-discharging section is determined as a preferred turning point in accordance with the characteristics of acceleration and deceleration along the main scanning directions. That is, the turning position P2 is located not right in front of the first target of negative-direction discharge P2 but farther in the positive main scanning direction than the target of negative-direction discharge P2. The distance from the target of negative-direction discharge 2b-1 to the turning position P3 is determined in accordance with the characteristics of acceleration and deceleration along the main scanning directions. In other words, the distance between the point where the ink-discharging section starts from rest to move along the main scanning directions and the point where the ink-discharging section reaches a constant velocity is determined. Thus, the determination of the turning position P2 causes the ink-discharging section to discharge ink while moving at a constant velocity along the main scanning directions, thus enabling more accurate discharge of ink at the first target of negative-direction discharge 2b-1.

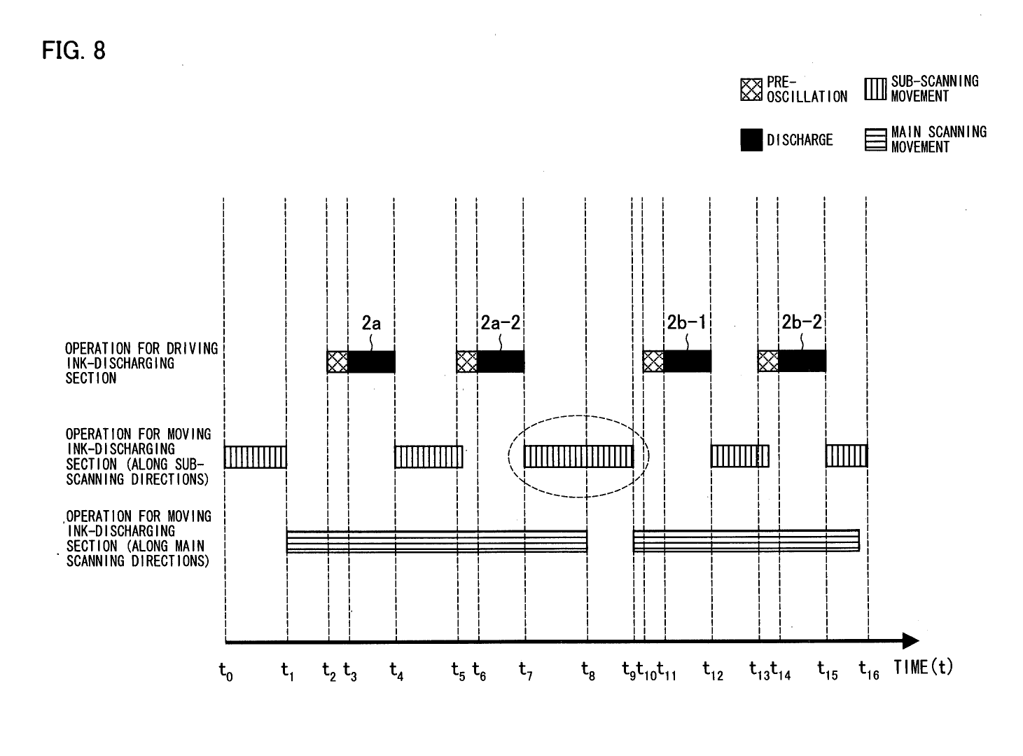

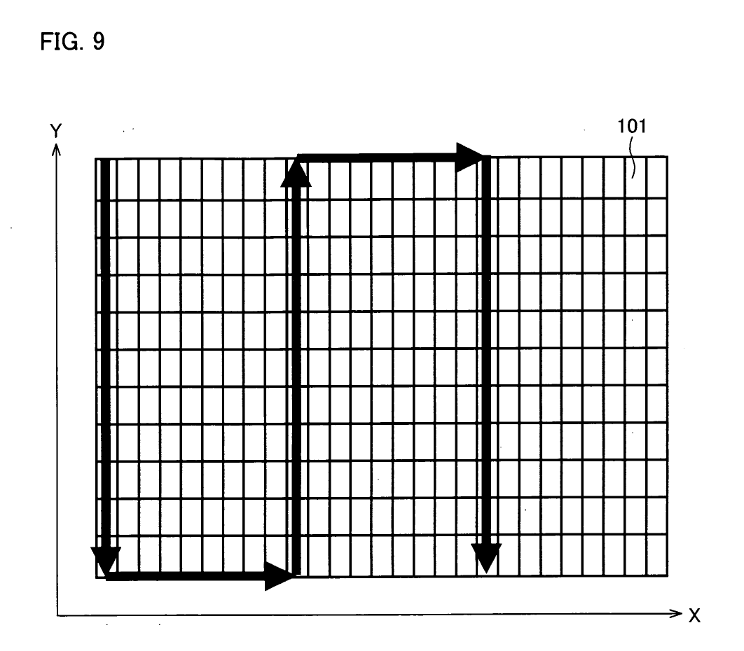

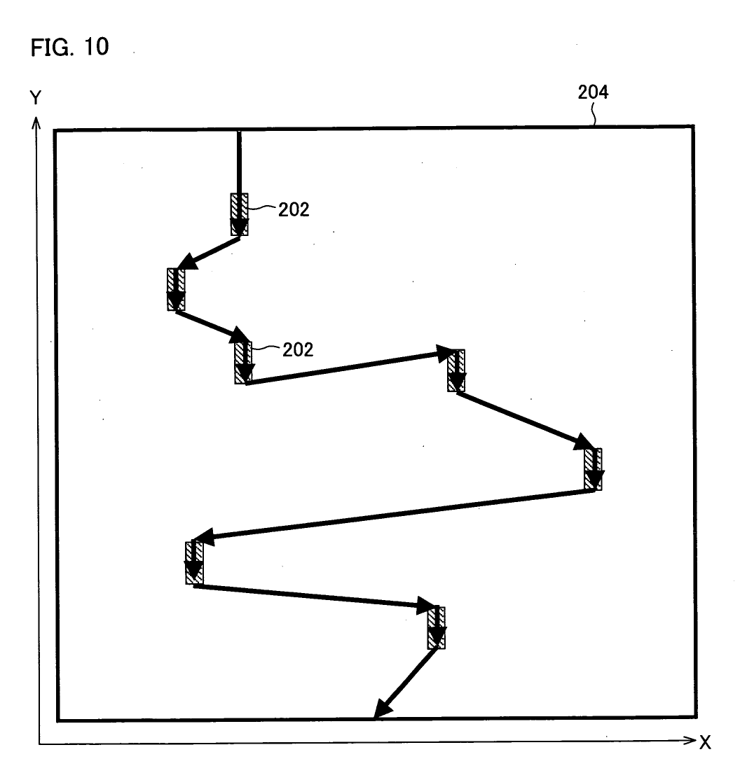

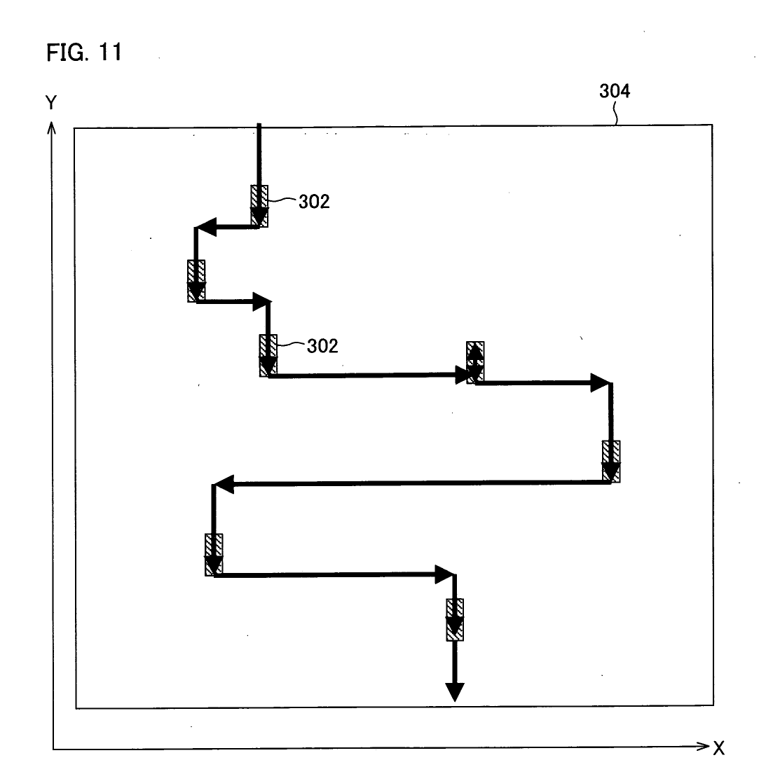

FIG. 8 is a pattern diagram showing how the ink-discharging section according to the present embodiment works and periods of time during which the ink-discharging section moves along the main scanning and sub-scanning directions. It should be noted that the operation of the ink-discharging section includes pre-oscillation. In FIG. 8, the horizontal axis represents passage of time.

From the point of time t0 to the point of time t1, the ink-discharging section moves in advance along the sub-scanning directions toward a target of positive-direction discharge 2a. Next, at the point of time t1, the ink-discharging section starts to move in the positive main scanning direction. The ink-discharging section moves at a constant velocity in the positive main scanning direction.

From the point of time t2 to the point of time t3, the ink-discharge section pre-oscillates before arriving at the target of positive-direction discharge 2a. The pre-oscillation is controlled by the ink discharge control section. The pre-oscillation causes the ink contained in the ink-discharging section to be stirred so that the viscosity of the whole ink is uniformed. The ink-discharging section pre-oscillates while moving.

At the point of time t3, the ink-discharging section arrives at the target of positive-direction discharge 2a. After that, the ink-discharging section discharges ink. The pre-oscillation caused in advance enables a reduction of change in state of ink discharge. At the point of time t4, the ink-discharging section finishes discharging ink, and then starts to move along the sub-scanning directions toward the last target of positive-direction discharge 2a-2 to which it moves next. At the point of time t5, the ink-discharging section starts to pre-oscillate, while moving along the sub-scanning directions. Thus, the ink-discharging section may pre-oscillate while moving along the sub-scanning directions. The ink-discharging section continues to pre-oscillate until the point of time t6.

Furthermore, from the point of time t6 to the point of time t7, the ink-discharging section discharges ink at the last target of positive-direction discharge 2a-2. At the point of time t7, the ink-discharging section finishes discharging ink, and then starts to move along the sub-scanning directions toward the first target of negative-direction discharge 2b-1 in starting to move from the last target of positive-direction discharge 2a-2 to the first target of negative-direction discharge 2b-1.

From the point of time t7 to the point of time t8, the ink-discharging section moves along the main scanning and sub-scanning directions. This enables a reduction in time required for the ink-discharging section to turn into the opposite main scanning direction until the point of time t9, at which the ink-discharging section arrives at the turning position. That is, the period of time from the point of time t7 to the point of time t8 can be reduced. After that, at the point of time t9, the ink-discharging section turns into the negative main scanning direction. It should be noted that the box, encircled by a dotted line in the center of FIG. 8, which represents a movement along the sub-scanning directions indicates the period of time during which the ink-discharging section moves between single movements in the main scanning directions. After that, from the point of time t10 to the point of time t16, the ink-discharging section discharges ink at the first target of negative-direction discharge 2b-1 and the last target of negative-direction discharge 2b-2 in the negative main scanning direction, and then turns into the opposite main scanning direction, as in the operation from the point of time t2 to the point of time t8.

As described above, the ink-discharging apparatus of the present invention is arranged such that: the ink-discharging means takes longer to move from one target of first-direction discharge to another along the main-scanning directions than along the sub-scanning directions and takes longer to move from one of the targets of second-direction discharge to another along the main-scanning directions than along the sub-scanning directions; that the ink-discharging means takes longer to move from the last one of the targets of first-direction discharge to the first one of the targets of second-direction discharge along the sub-scanning directions than along the main scanning directions, the last target of first-direction discharge being a target of first-direction discharge that the ink-discharging means scans last among the targets of first-direction discharge, the first target of second-direction discharge being a target of second-direction discharge that the ink-discharging means scans first among the targets of second-direction discharge; and the ink-discharging means starts to move along the sub-scanning directions toward the first target of second-direction discharge in starting to move from the last target of first-direction discharge to the first target of second-direction discharge.

This brings about an effect of enabling a reduction in time required for the discharging head to turn from a main scanning direction into the opposite main scanning direction, thus enabling accurate discharge of ink at a group of targets of ink discharge.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

An ink-discharging apparatus according to the present invention has ink-discharging means capable of turning from a main scanning direction into the opposite main scanning direction in a short period of time and accurately discharging ink at a group of targets of ink discharge. Therefore, the present invention can be used in the field of manufacture of various ink-discharging apparatuses, such as printers and liquid-crystal CF panel production apparatuses, and their components.

1. An ink-discharging apparatus comprising ink-discharging means,
the ink-discharging means being a component, capable of moving relative to a medium along main scanning directions and sub-scanning directions so as to discharge ink at a group of targets of ink discharge scattered about on the medium, which moves at a constant velocity along the main scanning directions,
the group of targets of ink discharge including (i) a plurality of targets of first-direction discharge at which the ink-discharging means discharges ink by identical scanning in a first one of the main scanning directions and (ii) a plurality of targets of second-direction discharge at which the ink-discharging means discharges ink by identical scanning in a second one of the main scanning directions opposite to the first direction,
the ink-discharging means taking longer to move from one target of first-direction discharge to another along the main-scanning directions than along the sub-scanning directions and taking longer to move from one of the targets of second-direction discharge to another along the main-scanning directions than along the sub-scanning directions,
the ink-discharging means taking longer to move from the last one of the targets of first-direction discharge to the first one of the targets of second-direction discharge along the sub-scanning directions than along the main scanning directions, the last target of first-direction discharge being a target of first-direction discharge that the ink-discharging means scans last among the targets of first-direction discharge, the first target of second-direction discharge being a target of second-direction discharge that the ink-discharging means scans first among the targets of second-direction discharge,
the ink-discharging means starting to move along the sub-scanning directions toward the first target of second-direction discharge in starting to move from the last target of first-direction discharge to the first target of second-direction discharge.

2. The ink-discharging apparatus as set forth in claim 1, wherein the ink-discharging means turns from the first main scanning direction into the second main scanning direction in accordance with a position of the last target of first-direction discharge along the main scanning directions and a position of the first target of second-direction discharge along the main scanning directions.

3. The ink-discharging apparatus as set forth in claim 1, wherein when the first target of second-direction discharge is located farther in the first main scanning direction than the last target of first-direction discharge, the ink-discharging means turns from the first main scanning direction into the second main scanning direction in accordance with a position of the first target of second-direction discharge.

4. The ink-discharging apparatus as set forth in claim 1, wherein when the last target of first-direction discharge is located farther in the first main scanning direction than the first target of second-direction discharge, the ink-discharging means turns from the first main scanning direction into the second main scanning direction in accordance with a position of the last target of first-direction discharge.

5. The ink-discharging apparatus as set forth in claim 1, wherein the ink-discharging means turns from the first main scanning direction into the second main scanning direction at a turning position determined in accordance with characteristics of acceleration and deceleration along the main scanning directions.
